(19) United States
(12) Patent Application Publication
(10) Pub. No.: US 2014/0095113 A1
(43) Pub. Date: Apr. 3, 2014

(54) METHOD AND APPARATUS FOR DETERMINING MAINTENANCE SECTIONS OF A RAIL

(71) Applicant: International Business Machines Corporation, Armonk, NY (US)

(72) Inventors: Shu Xia Cao, Ningbo (CN); Ning Duan, Shanghai (CN); Ke Hu, Beijing (CN); Li Li, Beijing (CN); Zhi Hu Wang, Beijing (CN); Xin Zhang, Beijing (CN)

(73) Assignee: International Business Machines Corporation, Armonk, NY (US)

(21) Appl. No.: 14/031,127

(22) Filed: Sep. 19, 2013

(30) Foreign Application Priority Data
Sep. 29, 2012 (CN) 201210379541.0

(51) Int. Cl. G01M 99/00

(52) U.S. Cl. CPC G01M 99/00
USPC 702/184; 705/400

(57) ABSTRACT

A method of determining maintenance sections of a rail includes partitioning the rail into a plurality of sections based on railway topographical information and track defect information; identifying, from the plurality of sections, sections whose sectional speed limits are lower than a recommended running speed; and determining, from the identified sections, sections which need maintenance.

### PRIORITY

This application claims priority to Chinese Patent Application No. 201210379541.0, filed Sep. 29, 2012, and all the benefits accruing therefrom under 35 U.S.C. §119, the contents of which in its entirety are herein incorporated by reference.

### BACKGROUND

The present invention relates to the technical field of rail maintenance, and more specifically, to a method and apparatus for determining maintenance sections of a rail.

In current rail maintenance, the maintenance is generally performed by sections; when a density of defect points in a section reaches a certain degree, the section will be subjected to maintenance. Defect points include, but are not limited to, detected rusty parts, cracks on a rail, and junction faults, etc.

However, the manner of partitioning sections in the prior art is simple. For example, the sections are partitioned in terms of ground parts and underground parts, or partitioned by urban areas and suburb areas, or partitioned by stations. It is seen that the existing section maintenance manner is a static partitioning manner, which does not consider other factors that affect speed limit, for example, topographical information, such that not all tracks in a determined maintenance section are needed to be maintained, which therefore causes unnecessary maintenance and increases maintenance costs.

Hence, it is desirable for a technical solution that can determine maintenance sections with actual condition information of a rail being taken into account, and the prior art therefore still has room to improve.

### SUMMARY

According to one aspect of the present invention, there is provided a method of determining maintenance sections of a rail, the method comprising: partitioning the rail into a plurality of sections based on railway topographical information and track defect information; identifying from the plurality of sections, sections whose sectional speed limits are lower than a recommended running speed; determining, from the identified sections, sections which need maintenance.

According to another aspect of the present invention, there is provided an apparatus for determining maintenance sections of a rail, the apparatus comprising: a partitioning module configured to partition the rail into a plurality of sections based on railway topographical information and track defect information; an identifying module configured to identify, from the plurality of sections, sections whose sectional speed limits are lower than a recommended running speed; and a determining module configured to determine, from the identified sections, sections which need maintenance.

Employing the technical solution of the present application can reduce unnecessary maintenance and lower the costs. In an improved embodiment, speed switching balance can also be kept among various sections, thereby enhancing the efficiency of rail maintenance and decrease component impairments caused by speed switch.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system which is applicable to implement the embodiments of the present invention;

FIG. 2 shows a flowchart of a method for determining maintenance sections of a rail according to the embodiments of the present invention;

FIGS. 3A and 3B show how to perform dynamic partitioning in one embodiment.

FIGS. 4A and 4B show how to determine priorities of maintenance sections in an improved embodiment;

FIG. 5 shows a schematic block diagram of determining maintenance sections of a rail.

### DETAILED DESCRIPTION

Exemplary embodiments will be described in more detail with reference to the accompanying drawings, in which the embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

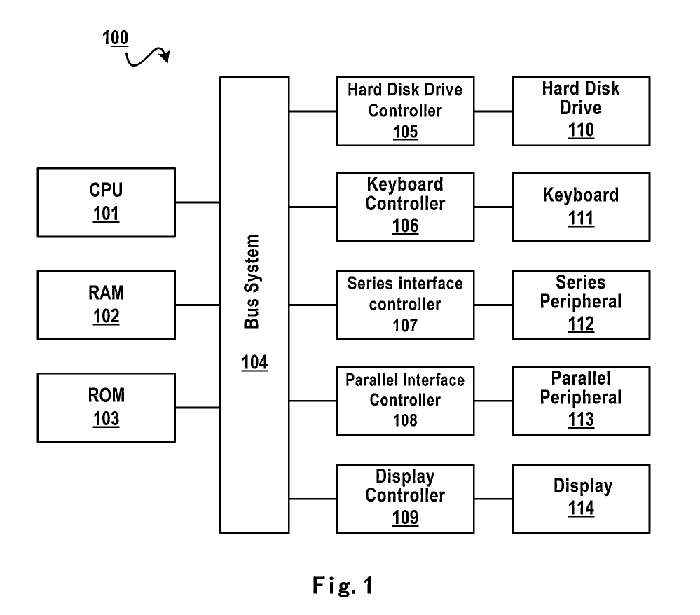

FIG. 1 shows an exemplary computer system 100 which is applicable to implement the embodiments of the present invention. As illustrated in FIG. 1, the computer system 100 may comprise: a CPU (Central Processing Unit) 101, a RAM (Random Access Memory) 102, a ROM (Read Only Memory) 103, a system bus 104, a hard disk controller 105, a keyboard controller 106, a serial interface controller 107, a parallel interface controller 108, a monitor controller 109, a hard disk 110, a keyboard 111, a serial peripheral device 112, a parallel peripheral device 113 and a monitor 114. Among these components, connected to the system bus 104 are the CPU 101, the RAM 102, the ROM 103, the hard disk controller 105, the keyboard controller 106, the serial interface controller 107, the parallel interface controller 108 and the monitor controller 109. The hard disk 110 is coupled to the hard disk controller 105; the keyboard 111 is coupled to the keyboard controller 106; the serial peripheral device 112 is coupled to the serial interface controller 107; the parallel peripheral device 113 is coupled to the parallel interface controller 108; and the monitor 114 is coupled to the monitor controller 109. It should be understood that the structure as shown in FIG. 1 is only for the exemplary purpose rather than any limitation to the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

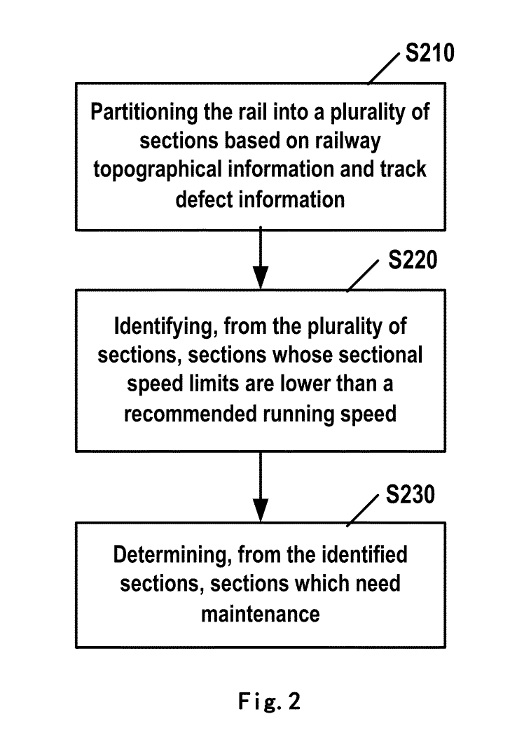

Hereinafter, a method of determining maintenance sections of a rail according to the embodiments of the present invention will be described with reference to FIG. 2.

In block 210, the rail is divided into a plurality of sections based on railway topographical information and track defect information.

Railway topographical information includes, for example, crooked road, mountain road, ramp, geology (frozen soil, sandy soil, etc.), and different topographies will have different impacts on speed limit, which is common knowledge in the field of railway. Track defect information includes, but not limited to, rust, cracks, junction impairments, sleeper fault, etc.; the track defect information, which will include types and locations of all defects as well as specific parameters of the defects, may be collected using common instruments, which is also common knowledge in the art.

In one embodiment, block 210 specifically comprises: determining a density curve of speed-affecting points of the rail, the speed-affecting points being determined based on the railway topographical information and the track defect information; and partitioning the sections based on a slope change of the density curve being greater than a predetermined numerical value.

Because both topographical information and track defect information will affect speed limit of a track, in one embodiment, each partitioned section may be made to have a uniform sectional speed limit after synthesizing the railway topographical information and track defect information; such “uniform” means sectional speed limits in one section are identical.

The calculation process of a sectional speed limit is mainly based on the existing various specifications in the railway field and determined through existing calculation formulas and their combinations. However, how to determine a sectional speed limit of a certain section based on the track condition information of the section is not a focus of the present invention, but common knowledge in the art, which will not be detailed here.

In block 220, identifying from the plurality of sections, sections whose sectional speed limits are lower than a recommended running speed.

In this block, the sectional speed limit of each section is compared with a recommended train speed, and “lower” may include the situation of “equal to.” In one embodiment, the recommended train speed is the average speed as determined by a train working timetable. If the sectional speed limit of one section is still higher than the recommended speed, it indicates that the section can satisfy the requirements of train working; if the sectional speed limits of all sections satisfy the recommended speed, it indicates that maintenance is not needed. Thus, through considering a relationship between the actual speed limit of the section and the recommended speed in this block, it can be determined whether maintenance is needed.

In block 230, determining from the identified sections, sections which need maintenance.

In one embodiment, the sections which need maintenance are all sections whose speed limits are lower than the recommended running speed.

In another embodiment, for the identified sections whose sectional speed limits are lower than the recommended running speed, the priorities and maintenance degrees of the to-be-maintained sections can be further determined.

For example, the priorities of the to-be-maintained sections may be determined based on a running speed of a smooth train. In one specific embodiment, determining to-be-maintained sections comprises: determining a maintenance cost model for a section whose sectional speed limit is lower than the recommended running speed; determining speed a smoothing model which lowers the speed difference between neighboring sections after maintenance; determining a priority and a maintenance degree of the to-be-maintained section based on the maintenance cost model and the speed smoothing model.

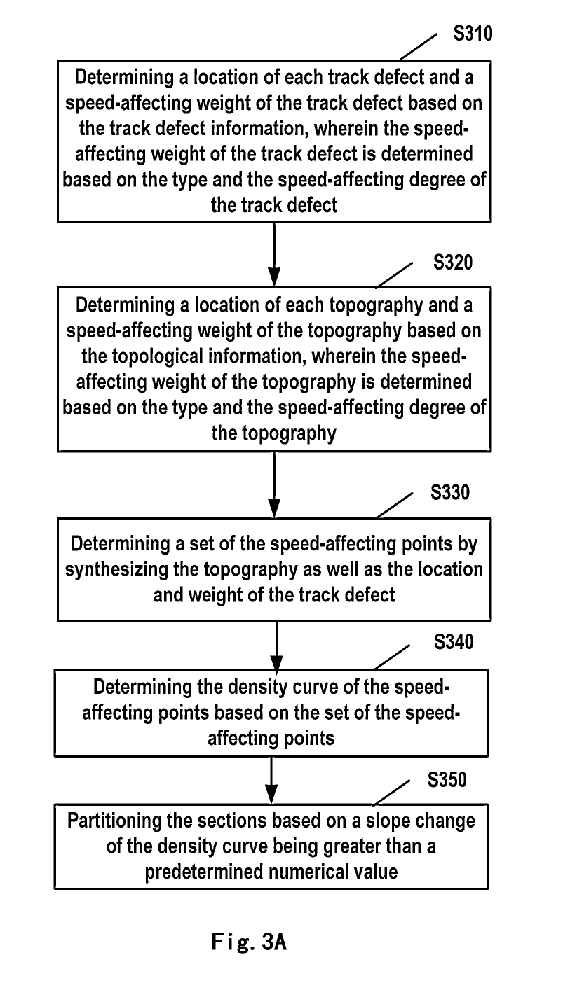

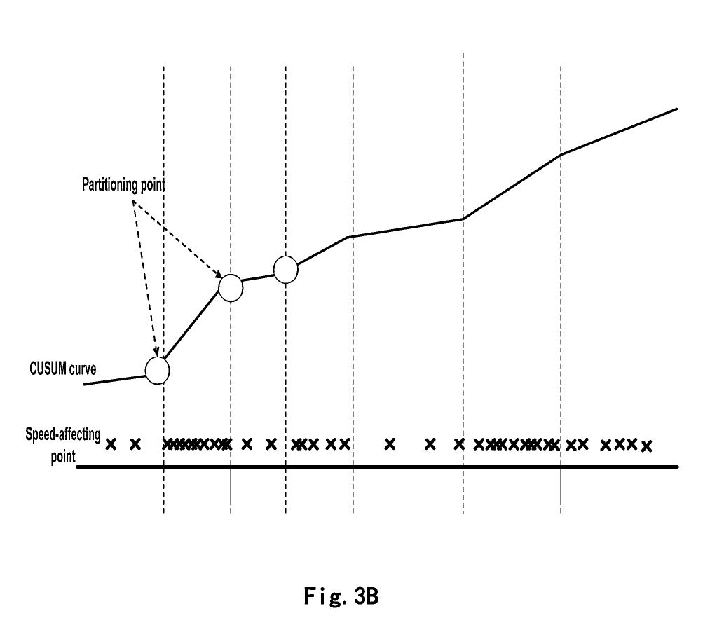

FIGS. 3A and 3B show how to perform dynamic partitioning in one embodiment. In this embodiment, the rail is dynamically partitioned into a plurality of sections with a uniform sectional speed limit based on the railway topographical information and the track defect information, of which the specific operations are as follows:

In block 310, a location of each track defect and a speed-affecting weight of the track defect are determined by the track defect information, wherein the speed-affecting weight of the track defect is determined based on the type of the track defect and the speed-affecting degree. For example, the defect points on the rail are normalized into a set of scores D={d1, d2, d3, . . . } having a weight based on the types (for example, sleepers, junctions, etc.) and seriousness degree, wherein di={location, weight score} is the location information of a defect point and a speed-affecting weight score.

In block 320, a location of each topography and a speed-affecting weight of the topography are determined based on the topographical information, and the speed-affecting weight of the topography is determined based on the type of the topography and the speed-affecting degree. For example, topographical information (for example, turn, mountain road, and ramp) that will affect travelling speed is converted into a set of scores T={a, t2, t3 . . . } having a weight based on its speed limit requirement, wherein ti={location, weight score} is the location information and the speed-affecting weight score of each piece of topographical information.

In block 330, a set of the speed-affecting points are determined by synthesizing the topography as well as the location and weight of the track defect. For example, the above-mentioned D set and T set are combined to form a set of speed-affecting points DT={dt1, dt2, dt3 . . . }.

In block 340, a density curve of the speed-affecting points is determined based on the set of the speed-affecting points.

In one embodiment, in block 340, a CUSUM (cumulative sum) curve of the set of speed-affecting points of the rail is used as the density curve: CUSUMi (dt1, dt2 . . . dti)=dt1+dt2+ . . . +dti, as shown in the CUSUM curve diagram of FIG. 3.

For example, CUSUM1=dt1, CUSUM2=dt1+dt2; CYSUM3=dt1+dt2+dt3.

In block 350, the section is partitioned based on the slope change of the density curve being greater than a predetermined numerical value. In one embodiment, with reference to the curve diagram as shown in FIG. 3B, for the CUSUM curve, the sections are partitioned with a point whose slop change ratio is greater than the predetermined numerical value as a partitioning point.

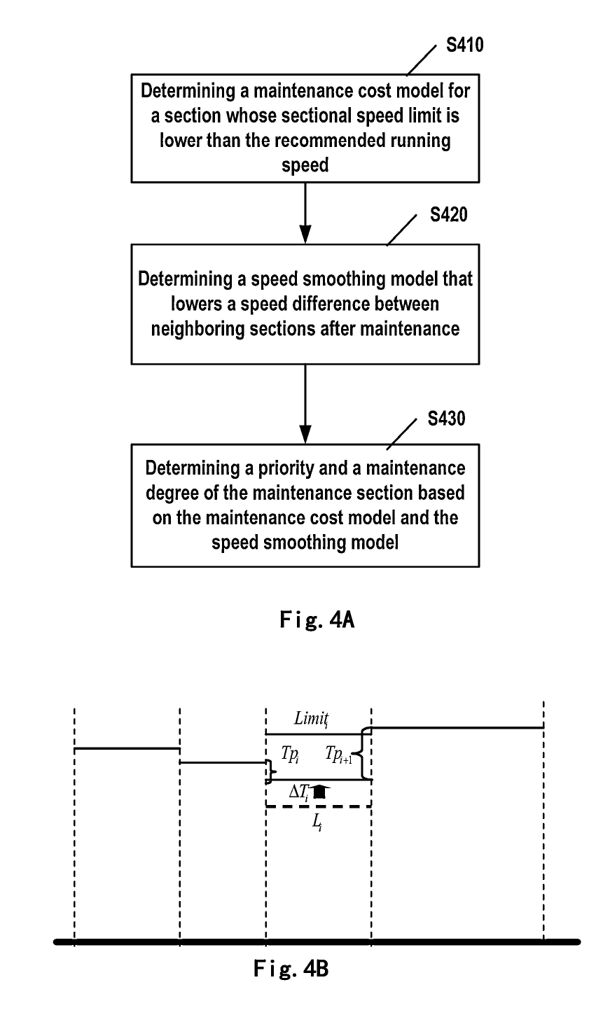

FIGS. 4A and 4B show how to determine priorities of maintenance sections in an improved embodiment. In this embodiment, after the speed differences between all neighboring sections are determined, the maintenance effect can be improved to the utmost with controlling maintenance cost. Since a great change of train speed during running will greatly affect the train throughput, oil consumption, and the abrasion degree of the rail, the maintenance effect is embodied through speed smoothing, i.e., the speed different between neighboring sections after maintenance is made to as least as possible. In one embodiment, a section to be maintained in priority and the maintenance degree can be determined through the following operations:

Block 410, determining a maintenance cost model for each section. In one embodiment, as shown in FIG. 4B, the maintenance cost for a single section is determined by a product of a sectional length (Lᵢ), a maintenance improvement amplitude (∇Tᵢ) which is an improvement amplitude of the sectional speed limit after maintenance, and a unit maintenance cost (MCᵤₙᵢₜ), wherein the unit maintenance cost is an empirical value provided by the user, the sectional length is determined based on the result of the above-mentioned partitioning, and the maintenance improvement amplitude is a decision variant. In the final result output by model operation, if the maintenance improvement amplitude of a section is 0, it indicates that this section needs no maintenance; if it is a positive number, then it indicates that the section should be maintained. Through the maintenance cost model, it may be ensured that the maintenance total costs (MCₜₒₜₐₗ) of all sections are controlled in a reasonable range (determined by the MCₜₒₜₐₗ input by the user); thus, in this block, the formula of the sectional maintenance cost model is specified as below:

$${\sum }_{i = 1}^{n} ( Δ {T}_{i} \times {L}_{i} \times {MC}_{unit} ) \leq {MC}_{total}$$

In block 420, determining a speed smoothing model that lowers the speed difference between neighboring sections after maintenance. The maintenance effect is embodied through speed smoothing, i.e., lowering the speed difference between neighboring sections to as least as possible. Meanwhile, the speed difference should consider the influence of the sectional length (for a relatively long section, it does not matter much for a relatively large speed difference; but for a very short section, a large speed difference will be a serious problem); thus, sectional length will be used to weight when performing speed smoothing. In one specific embodiment, as shown in FIG. 4B, for each section, the smoothing state after maintenance is determined by dividing the quadratic sum of the speed difference (Tpᵢ) between a speed of this section and a speed of an immediately preceding section and the speed difference (Tpᵢ₊₁) between the speed of this section and a speed of an immediately following section by the sectional length (Li); thus, after determining the smoothing state of each section after maintenance, it would not be difficult for those skilled in the art to determine the maintenance effect mode; in this block, the formula for the maintenance effect model is specified as below:

$$Min {\sum }_{i = 1}^{n} ( {Tp}_{i}^{2} + {Tp}_{i + 1}^{2} ) / {L}_{i}$$

In block 430, the priority and maintenance degree of the maintenance section are determined based on the maintenance cost model and the speed smoothing model. In one embodiment, the maintenance cost model and the speed smoothing model are input into an optimization engine (for example, the ilog optimization engine of IBM) which will provide a decision result based on the input models and some restriction conditions. With the above models, it is not an inventive focus of the present application how to determine a decision result using the optimization engine, which may be determined by existing operational research tools; it can be completely implemented by those skilled in the art, which will not be detailed here. The decision result is embodied as a recommended maintenance improvement amplitude (∇Tᵢ) of each section; if the maintenance improvement amplitude of a section is 0, it indicates that this section needs no maintenance; if it is a positive number, it indicates that this section should be maintained.

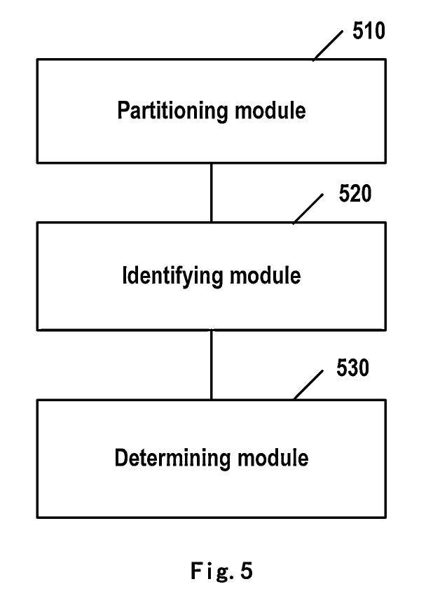

FIG. 5 shows a schematic block diagram of an apparatus for determining maintenance sections of a rail. The apparatus of FIG. 5 comprises:

A partitioning module 510 configured to partition the rail into a plurality of sections based on railway topographical information and track defect information; an identifying module 520 configured to identify, from the plurality of sections, sections whose sectional speed limits are lower than a recommended running speed; and a determining module 530 configured to determine, from the identified sections, sections which need maintenance.

In one embodiment, the partitioning module 510 comprises: a module configured to determine a density curve of speed-affecting points of the rail, the speed-affecting points being determined based on the railway topographical information and the track defect information; and a module configured to partition the sections based on a slope change of the density curve being greater than a predetermined numerical value.

In another embodiment, the module configured to determine a density curve of speed-affecting points of the rail comprises: a module configured to determine a location of each track defect and a speed-affecting weight of the track defect based on the track defect information, the speed-affecting weight of the track defect being determined based on a type and a speed-affecting degree of the track defect; a module configured to determine a location of each topography and a speed-affecting weight of the topography based on the topographical information, the speed-affecting weight of the topography being determined based on the type and the speed-affecting degree of the topography; a module configured to determine a set of the speed-affecting points through synthesizing the topography as well as the location and weight of the track defect; and a module configured to determine the density curve based on the set of speed-affecting points.

According to one embodiment of the present application, the module configured to determine the density curve of speed-affecting points of the rail takes the CUSUM curve of the set of speed-affecting points of the rail as the density curve; wherein the module configured to partition the sections based on a slope change of the density curve being greater than a predetermined numerical value comprises: a module configured to, for the CUSUM curve, use a point whose slop change ratio is greater than the predetermined numerical value as a partition point to partition the sections.

In one embodiment of the present application, the sections which need maintenance are all sections whose speed limits are lower than the recommended running speed.

In one embodiment of the present application, determining the sections determined need maintenance is that determining the priority of rail section maintenance based on a running speed of a smooth train, and determining sections to maintain based on the priority.

In one embodiment of the present application, the determining module 530 comprises: a module configured to determine a maintenance cost model for a section whose sectional speed limit is lower than the recommended running speed; a module configured to determine a speed smoothing model which lowers the speed difference between neighboring sections after maintenance; and a module configured to determine a priority and a maintenance degree of the to-be-maintained section based on the maintenance cost model and the speed smoothing model.

In one embodiment of the present application, determining a speed smoothing model by lowering the speed difference between neighboring sections after maintenance comprises: determining the smoothing state after maintenance by dividing the quadratic sum of the speed difference between a speed of this section and a speed of an immediately preceding section and the speed difference between the speed of this section and a speed of an immediately following section by the sectional length.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. This depends on relevant functions. It should also be noted that each block in the block diagrams and/or flowcharts and a combination of blocks in the block diagrams and/or flowcharts may be implemented by a dedicated hardware-based system for performing specified functions or operations or by a combination of dedicated hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of determining maintenance sections of a rail, the method comprising:
partitioning, with a processing device, the rail into a plurality of sections based on railway topographical information and track defect information;
identifying, from the plurality of sections, sections whose sectional speed limits are lower than a recommended running speed; and
determining, from the identified sections, sections which need maintenance.

2. The method according to claim 1, wherein the partitioning the rail into a plurality of sections based on railway topographical information and track defect information comprises:
determining a density curve of a speed-affecting points of the rail, the speed-affecting points being determined based on the railway topographical information and the track defect information; and
partitioning the sections based on a slope change of the density curve being greater than a predetermined numerical value.

3. The method according to claim 2, wherein determining a density curve of speed-affecting points of the rail comprises:
determining a location of each track defect and a speed-affecting weight of the track defect based on the track defect information, wherein the speed-affecting weight of the track defect is determined based on the type and the speed-affecting degree of the track defect;
determining a location of each topography and a speed-affecting weight of the topography based on the topological information, wherein the speed-affecting weight of the topography is determined based on the type and the speed-affecting degree of the topography;
determining a set of the speed-affecting points by synthesizing the topography as well as the location and weight of the track defect; and
determining the density curve based on the set of speed-affecting points.

4. The method according to claim 3, wherein:
the determining the density curve based on the set of speed-affecting points comprises using a CUSUM curve of the set of speed-affecting points of the rail as the density curve; and
the partitioning the sections based on a slope change of the density curve being greater than a predetermined numerical value comprises: for the CUSUM curve, taking a point whose slop change ratio is greater than the predetermined numerical value as a partitioning point to partition the sections.

5. The method according to claim 1, wherein the sections which need maintenance are all sections whose speed limits are lower than the recommended running speed.

6. The method according to claim 1, wherein the determining sections, which need maintenance, among the identified sections comprises:
determining a maintenance cost model for a section whose sectional speed limit is lower than the recommended running speed;
determining a speed smoothing model that lowers a speed difference between neighboring sections after maintenance; and
determining a priority and maintenance degree of the maintenance section based on the maintenance cost model and the speed smoothing model.

7. The method according to claim 6, wherein the maintenance cost model is determined based on a product of a sectional length, a maintenance improvement amplitude, and a unit maintenance cost.

8. The method according to claim 6, wherein the determining a speed smoothing model which lowers the speed difference between neighboring sections after maintenance comprises: determining a smoothing state after maintenance by dividing the quadratic sum of the speed difference between a speed of this section and a speed of an immediately preceding section and the speed difference between the speed of this section and a speed of an immediately following section by the sectional length.

9. An apparatus for determining maintenance sections of a rail, apparatus comprising:
a partitioning module configured to partition the rail into a plurality of sections based on railway topographical information and track defect information;
an identifying module configured to identify, from the plurality of sections, sections whose sectional speed limits are lower than a recommended running speed; and
a determining module configured to determine, from the identified sections, sections which need maintenance.

10. The apparatus according to claim 9, wherein the partitioning module comprises:
a module configured to determine a density curve of speed-affecting points of the rail, the speed-affecting points being determined based on the railway topographical information and the track defect information; and
a module configured to partition the sections based on a slope change of the density curve being greater than a predetermined numerical value.

11. The apparatus according to claim 9, wherein the module configured to determine a density curve of speed-affecting points of the rail comprises:
a module configured to determine a location of each track defect and a speed-affecting weight of the track defect based on the track defect information, wherein the speed-affecting weight of the track defect is determined based on the type and the speed-affecting degree of the track defect;
a module configured to determine a location of each topography and a speed-affecting weight of the topography based on the topological information, wherein the speed-affecting weight of the topography is determined based on the type and the speed-affecting degree of the topography;
a module configured to determine a set of the speed-affecting points by synthesizing the topography as well as the location and weight of the track defect; and
a module configured to determine the density curve based on the set of speed-affecting points.

12. The apparatus according to claim 10, wherein:
the module configured to determine the density curve of speed-affecting points of the rail uses a CUSUM curve of the set of speed-affecting points of the rail as the density curve; and
wherein the module configured to partition the sections based on a slope change of the density curve being greater than a predetermined numerical value comprises: a module configured to, for the CUSUM curve, take a point whose slop change ratio is greater than the predetermined numerical value as a partitioning point to partition the sections.

13. The apparatus according to claim 9, wherein the sections which need maintenance are all sections whose speed limits are lower than a recommended running speed.

14. The apparatus according to claim 9, wherein the determining module comprises:
a module configured to determine a maintenance cost model for a section whose sectional speed limit is lower than the recommended running speed;
a module configured to determine a speed smoothing model that lowers a speed difference between neighboring sections after maintenance; and
a module configured to determine a priority and a maintenance degree of the maintenance section based on the maintenance cost model and the speed smoothing model.

15. The apparatus according to claim 14, wherein the maintenance cost model is determined based on a product of a sectional length, a maintenance improvement amplitude, and a unit maintenance cost.

16. The apparatus according to claim 14, wherein the module configured to determine a speed smoothing model which lowers the speed difference between neighboring sections after maintenance comprises: a module configured to determine a smoothing state after maintenance by dividing the quadratic sum of the speed difference between a speed of this section and a speed of an immediately preceding section and the speed difference between the speed of this section and a speed of an immediately following section by the sectional length.
